(19) United States
(12) Patent Application Publication
(10) Pub. No.: US 2002/0188434 A1
(43) Pub. Date: Dec. 12, 2002

(54) SYSTEM AND METHOD FOR PROVIDING CROSS-DEVELOPMENT APPLICATION DESIGN TOOLS AND SERVICES VIA A NETWORK

(76) Inventors: Pauline Shulman, San Francisco, CA (US); Caroline L. Yao, Alameda, CA (US); William Dere, Alameda, CA (US); John Hartman, Oakland, CA (US)

Correspondence Address: Oleg F. Kaplun, Fay Kaplun & Marcin, LLP, 100 Maiden Lane, 17th Floor, New York, NY, 10038, US

(21) Appl. No.: 09/879,309

(22) Filed: Jun. 12, 2001

(51) Int. Cl. G06F 9/44; G06F 13/10

(52) U.S. Cl. 703/21; 703/23

(57) ABSTRACT

A software package for application development comprises an input module for receiving from a user information corresponding to a desired application to be developed and a reference database including data on each of plurality of categories for which the application may be developed. The software package also includes a component database storing a plurality of design components therein and an analysis module which selects from the component database design components suitable for the desired application based on the user information and the data in the reference database.

### BACKGROUND INFORMATION

Application software is often developed through “cross-development.”Cross-development allows a software developer to develop an application in a first (“host”) computing environment that will ultimately be executed in a second (“target”) computing environment. For example, cross-development is commonly employed in the development of applications for so-called “embedded systems,” because such embedded systems may not provide the type of computing resources needed to support application development in the “native” embedded system. In such situations, a cross-development environment may be implemented in a general purpose computing environment (e.g., a workstation) that allows for the creation, debugging and simulation of applications for the embedded system. In addition, the host computing environment may be different than the target embedded computing environment—for example, different processors, different hardware configurations, different operating systems—but the cross-development environment provides facilities that allow for the development of application software that will be capable of executing in the target environment.

Cross-development environments may further allow for the transmission and loading of developed applications into a target system. For example, as part of the cross-development process, a developer may desire that an application under development be evaluated and debugged (e.g., by emulation or logic analysis) while actually running in the physical target environment. In addition, such evaluation may be needed in order to perform quality assurance testing prior to customer shipment. To facilitate such evaluation and debugging, a target computing environment (for example, an evaluation board) may be coupled to the host computing environment, and the cross-development environment may include facilities to enable communication with the target. Typically this coupling is achieved using a physical cable connection and a logical passing of information using a serial or Ethernet format. The host environment and the target environment will include communication management software to facilitate the connection.

The typical cross-development software suite may not be available to developers in all situations. For example, small companies may not be able (or may not want) to incur the cost of purchasing a cross-development software suite. Moreover, such organizations may not want to purchase all of the tools provided in the cross-development software suite (since only certain tools will be primarily used in the development of a particular application). In either case, however, situations may arise which may require the use of non-purchased tools for special circumstances during development. In addition, the typical host computing environment may not be available in all situations (for example, a field engineer attempting to provide services at a remote customer site), thus preventing the use of the typical cross-development software suite.

Software developers originally created all application software from scratch, writing each line of code for the particular application that they were developing. As developers began to build their own library of proprietary code, they began to piece together different pieces of this legacy proprietary code to create new applications from existing software code, thereby saving some time in the development process. The benefits of software re-use have caused many developers to prefer buying or using commercially available code rather than writing their own code. One particular field of commercial code is real-time operating systems (“RTOS”) which are typically used in embedded computing environments. This use of commercially available RTOSs by developers fueled the creation of a third party hardware and software vendor market (“TSV”). These TSVs created a huge number of software building blocks designed to inter-operate with, or plug-in to the commercial-off-the shelf RTOS for the efficient development of systems and devices.

Software developers who desire to use these software building blocks must identify and locate the specific building blocks that are most useful for their application. Since there are a large number of TSV building blocks, cataloging and becoming familiar with the features of each of these blocks is a time consuming task. Furthermore, identifying the interdependencies among the various building blocks makes this task more difficult. Because only certain TSV blocks are useable with certain hardware and certain RTOSs, determining which building blocks inter-operate with hardware reference platforms or components and selecting the TSV block best suited to meet design goals such as performance benchmarks, cost and/or power requirements can be cumbersome.

### SUMMARY

The present invention is directed to a software package for application development comprising an input module for receiving from a user information corresponding to a desired application to be developed and a reference database including data on each of plurality of categories for which the application may be developed in combination with a component database storing a plurality of design components therein and an analysis module which selects from the component database design components suitable for the desired application based on the user information and the data in the reference database.

### BRIEF DESCRIPTION OF DRAWINGS

FIG. 1 shows a cross-development software suite that includes a number of software development “tools” according to the present invention;

FIG. 2 shows an exemplary embodiment of a remote system according to the present invention;

FIG. 3 shows an exemplary process for a remote client to access software development tools from a vendor according to the present invention;

FIG. 4 shows an exemplary block diagram of a solution module according to the present invention;

FIG. 5 shows a block diagram for an exemplary reference design in a solution module according to the present invention;

FIG. 6 shows an exemplary process flow for the use of a solution module according to the present invention;

FIGS. 7a-f show exemplary graphical user interfaces for a solution module according to the present invention;

FIGS. 8a-b show exemplary design output screens for a graphical user interface for a solution module according to the present invention;

FIG. 9 shows an example of an implementation and use of a remote target collection according to the present invention;

FIG. 10 shows an exemplary target system according to the present invention;

FIG. 11 shows an exemplary target server according to the present invention;

FIG. 12 shows an exemplary connection between a cross-development software suite running on a computing platform 60 and a target collection according to the present invention;

FIG. 13 shows an exemplary graphical user interface for a target system according to the present invention;

FIG. 14 shows an exemplary process flow for operation of target systems according to the present invention;

FIG. 15 shows an exemplary graphical user interface which shows the status of a particular target system over a 24 hour period, according to the present invention.

### DETAILED DESCRIPTION

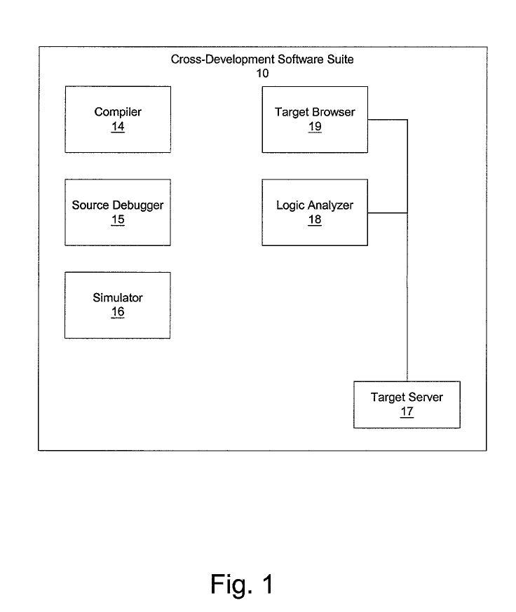

The present invention may be further understood with reference to the following description of preferred embodiments and the related appended drawings, wherein like elements are provided with the same reference numerals. FIG. 1 shows cross-development software suite 10 that includes, for example, a number of software development “tools”: compiler 14, source level debugger 15, and simulator 16. Additional tools are provided in cross-development software suite 10 that may be used to interact with a target computing environment: logic analyzer 18, target browser 19 and target server 17 that facilitates communication between the tools of cross-development software suite 10 and a target computing environment. Each of the tools may request information from and/or send information to the target computing environment via target server 17. The target computing environment will be discussed in greater detail below. One example of a cross-development software suite is the Tornado® integrated development environment (IDE) sold by Wind River Systems, Alameda, Calif.

According to a preferred embodiment of the present invention, cross-development may be performed through the use of a remotely accessible collection of cross-development software tools. Each of the software tools is accessible via a network connection—for example, via the Internet—through an interface served to a requesting client. The software tools are executed on platforms remote from the requesting client, based on the instructions provided in the interface. Accordingly, the user can access specific tools as needed, without having to install the software tools locally, or to incur the full expense of purchasing development tools or equipment that may be used only infrequently.

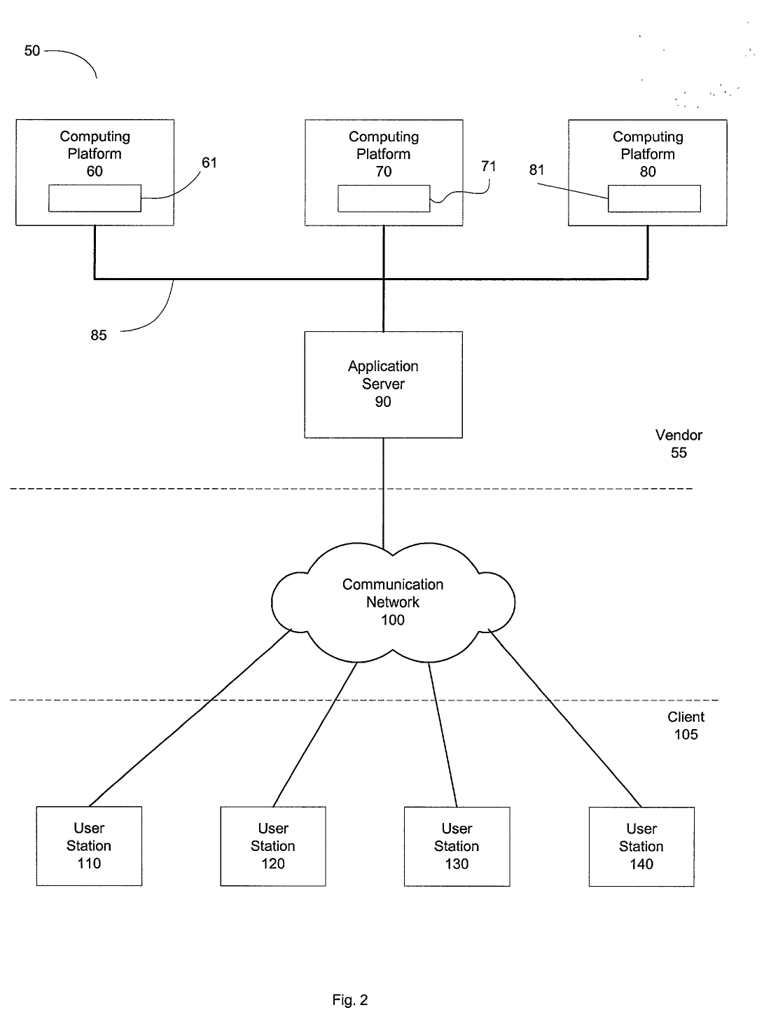

FIG. 2 illustrates an exemplary embodiment of a remote system 50 according to the present invention. Software development tools 61-81 are provided on a number of computing platforms 60-80, respectively. Computing platforms 60-80 may be, for example, computer servers running the Windows NT® Server operating system. Software development tools 61-81 may comprise any of the available cross-development tools used for software development, for example, cross-development software suite 10 described with reference to FIG. 1. This particular example may be, for example, the development tools provided in the Tornado® IDE available from Wind River Systems. As will be understood by those skilled in the art, the number of computing platforms 60-80 used may be selected based on the expected demand for usage of the development tools 61-81, and the need for redundancy to provide for fail-safe operating in the case of system malfunctions. Each of the computing platforms 60-80 is coupled to application server 90 via network 85 which may be, for example, an Ethernet network. The application server 90 is connected to communication network 100 (e.g., the Internet). User stations 110-140 are also connected to communication network 100. Those skilled in the art will understand that the connections in FIG. 2 are only exemplary and that computing platforms 60-80 and one or more of user stations 110-140 may be connected to communications network 100 by a variety of connection methods. For example, computing platforms 60-80 may be directly connected to communication network 100, user stations 110-140 may be inter-connected via a local area network (“LAN”) which is connected to communication network 100, etc.

In the exemplary embodiment of FIG. 2, computing platforms 60-80 and application server 90 may be considered a “vendor” 55 of software development tools 61-81 and user stations 110-140 maybe considered “purchasers” software development tools 61-81 and will be referred to as client 105 throughout this specification. Those of skill in the art will understand that clients 105 may access any number of vendors 55 via the communication network 100 and that any of the individual vendors 55 may include computing platforms coupled to any number of application servers 90. Vendor 55 maybe a developer of software development tools 61-81 or an entity licensed to sell and/or distribute the product. For example, as described above, the software development tools 61-81 may be the Tornado® IDE available from Wind River Systems. In this example, Wind River Systems as vendor 55 may set up computing platforms 60-80 and application server 90 in order to distribute the Tornado® IDE product to user stations 110-140 through communication network 100. Those skilled in the art will understand that vendor 55 does not need to be limited to a single entity. For example, vendor 55 may consist of first and second software vendors with each contributing a portion of software development tools 61-81. In this case, the first and second software vendors may contribute to the construction and maintenance of computing platforms 60-80 and application server 90, while sharing in the financial benefits from and/or responsibilities for the system.

In a “electronic” software commerce model, when a client 105 using one or more of user stations 110-140 desires to purchase software development tools 61-81, client 105 makes a request through communication network 100 to vendor 55 to purchase software development tools 61-81 with the appropriate payment. Vendor 55 then transmits a copy of software development tools 61-81 through communication network 100 to client 105 (e.g., a “dowload”) who installs software development tools 61-81 on the local station (e.g., user station 110). Client 105 may then use software development tools 61-81 to develop application software. This transaction is not qualitatively different from a traditional transaction where a purchaser buys a software product via a sales facility and receives the product on storage media (e.g., floppy disk, compact disk) which is then taken to a local station and installed via a disk drive. The only difference in the electronic software commerce model is that the software product is transmitted over the communication network 100 rather than being sold via storage and transport using storage media.

In contrast, remote system 50 allows client 105 to use software development tools 61-81 without installing them on user stations 110-140. Client 105 uses user stations 110-140 to remotely access software development tools 61-81 by sending a request to application server 90 through communication network 100. Application server 90 makes software development tools 61-81 available to client 105. However, software development tools 61-81 continue to be executed remotely from client 105 on computing platforms 60-80 with fees payable, for example, based on an amount or time of use. In this manner, client 105 does not incur the full expense of purchasing software development tools 61-81. Client 105 may find this arrangement advantageous because paying for the use of software development tools 61-81 on a time or project basis may be more cost effective than purchasing software development tools 61-81. For example, client 105 may be the developer of an embedded device (e.g., a wireless telephone) designed by a third party. The third party designer may include a standard set of application software in the design. However, if the developer desires to add additional application software to the device, but does not have the required software development tools 61-81, the remoste system 50 according to the preferred embodiment of the present invention allows the developer to access software development tools 61-81 on an as-needed basis.

Vendor 55 may make software development tools 61-81 available via remote system 50 to clients 105 to reach a segment of the market that vendor 55 may not otherwise be able to target. For example, if the choice for an embedded device developer is to either purchase a complete copy of software development tools 61-81 to implement the desired application software or to forego purchase of software development tools 61-81 and not include the desired application software, the developer may opt to not purchase software development tools 61-81. In this case, vendor 55 will sell no product and will generate no revenue from this potential client. By making software development tools 61-81 available to the developer through remote system 50, vendor 55 may generate revenue which would otherwise not be realized. Additionally, vendor 55 may also make software development tools 61-81 available via remote system 50 at some reduced pricing structure to allow potential clients 105 to evaluate software development tools 61-81.

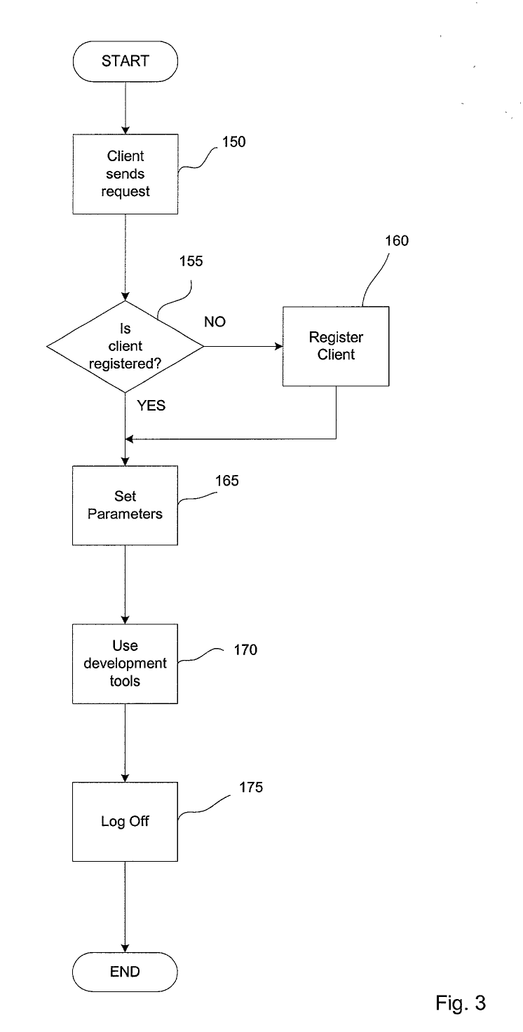

FIG. 3 shows an exemplary process by which remote client 105 may access software development tools 61-81 from vendor 55. In step 150, client 105 at user station 110 sends via communication network 100, a request to application server 90 for use of software development tools 61-81. Application server 90 exposes an interface over the communication network 100 which allows user station 110 to connect to application server 90. The interface may be, for example, an HTML file (also referred to as a “page”) which may be displayed by an HTML browser and may, for example, further include Java applets. The interface may include instructions and facilities to permit the use of the cross-development software suite 10 by remote clients 105. User stations 110-140 may include network connection facilities to allow client 105 to communicate over communications network 100. User stations 110-140 may comprise a computer workstation with extensive computing resources, however, it may also comprise minimal computing resources (a so-called “thin” client). User stations 110-140 may include a facility to permit connection to the interface exposed by application server 90, for example, an HTML browser including a Java Virtual Machine. It should be noted that there may be multiple clients 105 at each of the remote user stations 110-140 making a similar request at the same or different times. User stations 110-140 do not need to be related in any manner and may be separated spatially by hundreds or even thousands of miles. For example, user station 110 may be at the offices of the embedded device developer described above, while user station 120 may be at the offices of the third party embedded device designer described above. In other words, user stations 110-140 may be at any location with access to communication network 100.

In step 155, application server 90 determines whether client 105 is registered to use software development tools 61-81. If client 105 is not registered, the process continues to step 160 where client 105 registers with application server 90. Registration may include, for example, setting up a user identification and password, making payment arrangements (e.g., setting access to a credit card or customer billing account), and setting use and/or billing preferences. Vendor 55 may package software development tools 61-81 in any number of manners for clients 105. For example, software development tools 61-81 may have multiple features and client 105 may desire to only use a selected set of these features which client 105 may set as the default parameters in a profile during registration. Thus, each time client 105 returns to use software development tools 61-81 these will be the default parameters. Vendor 55 may also have numerous manners of billing clients 105 for use of software development tools 61-81. For example, a first client 105 may desire to pay for use of software development tools 61-81 on a time basis (e.g., hourly, daily, weekly, etc.), while a second client 105 may desire to pay on an event basis (e.g., fixed rate for a project, fixed rate per number of compiles, etc.).

After client 105 registers in step 160, or if client 105 is already registered in step 155, the process continues to step 165 where client 105 sets the parameters for the current session. Client 105 may select to remain with the default parameters or may change these parameters for the current session. If the parameter for billing is on a time basis, application server 90 may begin timing the current session for billing purposes. Application software 90 may also access and make available work performed previously by client 105 and stored by vendor 55. For example, in a previous session, client 105 may have entered numerous lines of code for a particular project. One option available to client 105 may be to store these lines of code on a portion of a hard drive (not shown) provided by vendor 55. When client 105 begins a new session, these previously stored lines of code may be made available to client 105.

The process then continues to step 170 where client 105 remotely uses software development tools 61-81. In general, remote use of software development tools 61-81 will entail client 105 issuing commands (or instructions) from user stations 110-140. These commands will be transmitted to application server 90 via communication network 100. Application server 90 will transmit these commands to the appropriate one of computing platforms 60-80 on which the current session is running. The corresponding one of software development tools 61-81 will execute the command and the results of this execution will be transmitted back to client 105. For example, client 105 may issue commands to enter (e.g., upload) certain lines of software code. When these lines of code have been entered, client 105 may desire to compile and run the software code. Client 105 at user stations 110-140 will issue commands for the software code to be compiled and run. These commands will be transmitted via communication network 100 to application server 90 which will forward the commands to the appropriate computing platform 60-80. The commands will then be executed by software development tools 61-81. The results of these commands (e.g., the successful or unsuccessful compiling and running of the software code) will then be transmitted back to client 105, who then may issue additional commands to be executed by software development tools 61-81. More specific operations that may be carried out by software development tools 61-81 will be described in detail below. When client 105 has finished with the current session, the process continues to step 175 where client 105 logs out of application server 90 and the session ends.

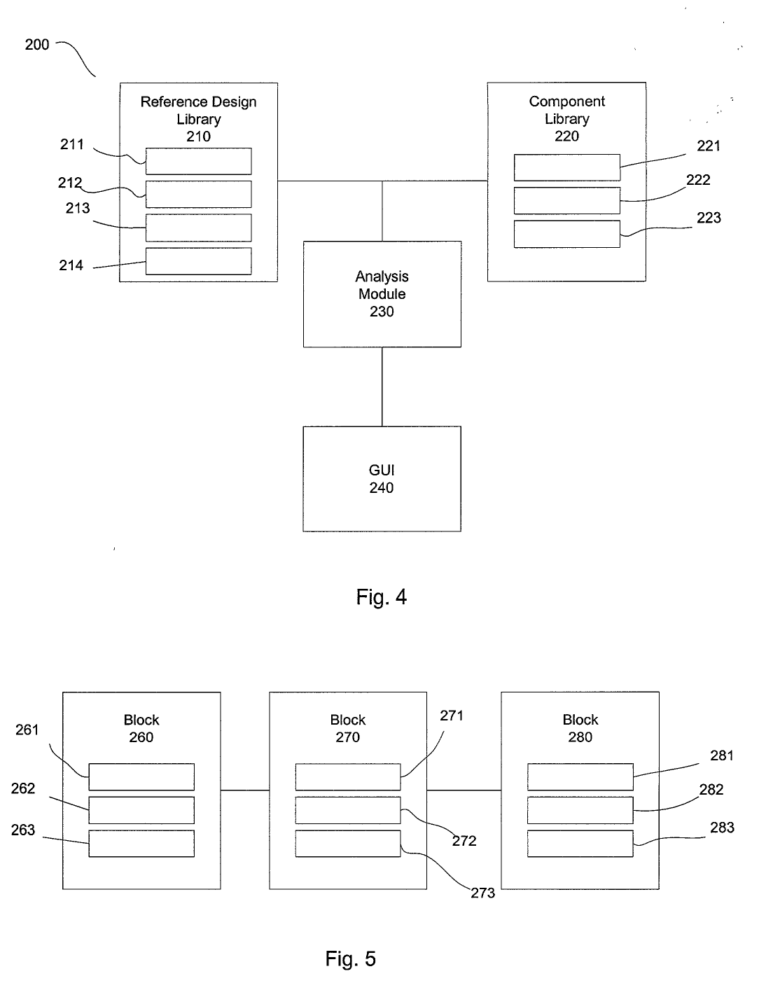

One of the applications that may be included in software development tools 61-81 is a solution module which assists clients 105 in designing devices by identifying software building blocks that may be useful in the design of particular devices. Those of skill in the art will understand that the solution module described below relates to an application provided to clients 105 who access software development tools 61-81 through remote system 50. However, the solution module may also be sold as part of software development tools 61-81 in a traditional manner where client 105 installs software development tools 61-81 locally. FIG. 4 shows an exemplary block diagram of solution module 200 including a reference design library 210, component library 220, analysis module 230 and graphical user interface 240. Reference design library 210 contains information about existing reference designs 211-214. For example, reference design library 210 may contain information about the design of different classes of embedded devices (i.e., devices that include microprocessors but which are not traditional computers). Furthermore, those skilled in the art will understand that this invention is equally applicable to the development of solutions for traditional computers as well as for embedded devices. For example, it may be desirable for an embedded device to be networked with another electronic device. This networking may be via the Internet, a LAN, a wireless network or any other manner of connecting two or more electronic devices. Any device may become a networked device when provided with the capability to connect with another device. For example, wireless telephones, PDAs, refrigerators (or other home appliances), office products, factory automation products, automotive components, security devices, etc. Thus, reference designs 211-214 may be for any specific ones or types of these devices (e.g., reference design 211 may be for a wireless telephone, reference design 212 may be for a PDA, etc.). There may also be multiple designs for a single type of device, for example, reference designs 211-213 may be three standard designs for different embedded printing devices. Additionally, the reference design may be in the form of a template that includes multiple features that may be included in the desired device. Use of such a template will be described in greater detail below.

FIG. 5 shows a block diagram for exemplary reference design 211. In this example, reference design 211 shows three blocks 260-280 typically used for the design of the device. For example, if reference design 211 is for a wireless telephone, blocks 260-280 may be three different types of integrated circuits typically used in the design of wireless telephones. Reference design 211 may also contain information about the type and model of integrated circuit that may be used as a particular component. For example, block 260 shows three components 261-263 that may be used to provide the function of component 260. Following through with the example of block 260 being an integrated circuit, components 261-263 may be integrated circuits manufactured by Intel®, Motorola® and AMD®, respectively. Each of the information about components 261-263 is contained in component library 220 as will be described in greater detail below. The information included in a component entry may be the type of information generally included in a data sheet for an integrated circuit device (e.g., name, model number, developer, power requirements, package type, operating ranges, cost, etc.). Those skilled in the art will understand that the reference design does not need to reference any specific hardware component, and may also reference software components. For example, reference design 211 may be for a paging routine for a wireless telephone. In this case, components 260-280 may be three software blocks needed to build the paging routine.

Reference design library 210 may be built using the existing knowledge base of vendor 55. For example, vendor 55 may have application engineers that aid clients in using software development tools 61-81 in the design of their devices. In the course of rendering such aid, the application engineers become familiar with various designs for products. This knowledge base of vendor 55 may then be incorporated within reference design library 210. Another manner of adding information to reference design library 210 may be through alliances and partnerships with developers of components (e.g., components 261-263). As a partner, the component developer may provide standard designs of products in which their components may be used, including the specifications for the components. Additionally, clients 105 may also provide standard designs for products which they desire to design. Those skilled in the art will understand that there are numerous other manners of building reference design library 210.

Referring back to FIG. 4, component library 220 contains a complete description of all available components (e.g., components 221-223). Components library 220 may contain information about both hardware components (e.g., processors) and software components (e.g., browsers). Component library 220 may be built in the same manner as reference design library 210 (e.g., existing knowledge base of vendor 55, partnerships with TSVs, etc.). The components 221-223 description may include, for example, the type of device for which the block may be used, the type of component on which the block may be used, the cost of the Software block and compatibility of the operating system. Analysis module 230 may contain information about the relationships and interdependencies between the various components. Analysis module 230 may be, for example, a knowledge engine or database containing the described information. For example, analysis module 230 may indicate that component 221 is incompatible with component 223, or that when component 222 is used, component 223 must also be used, etc. The user accesses all these components of solution module 200 through graphical user interface 240 which will be described in greater detail below. Vendor 55 may continuously update, either manually or through automation functions, each of reference design library 210, component library 220 and analysis module 230 as new information becomes available.

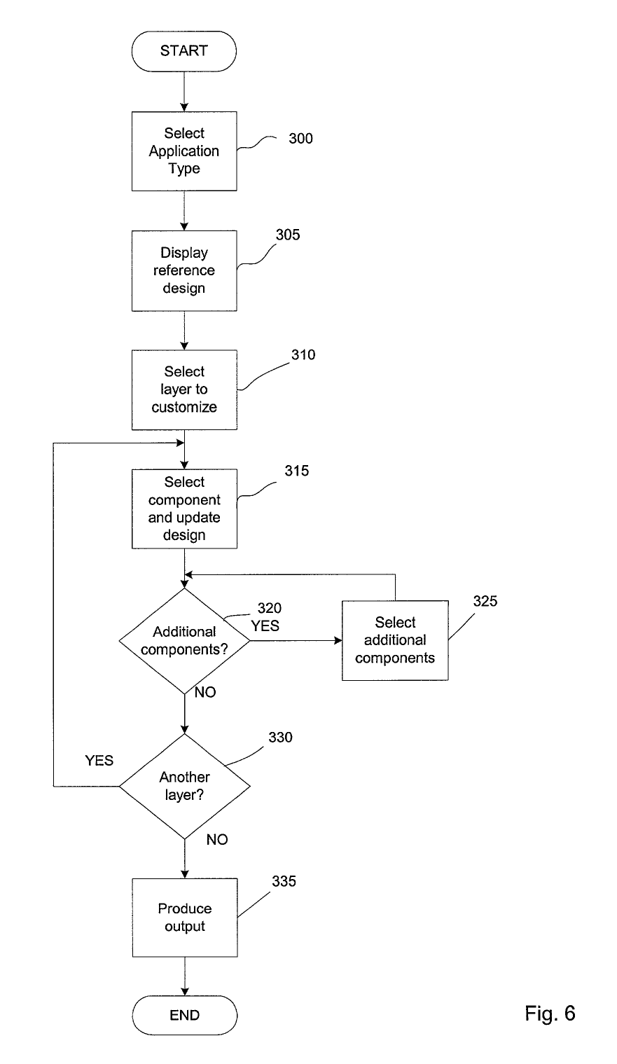

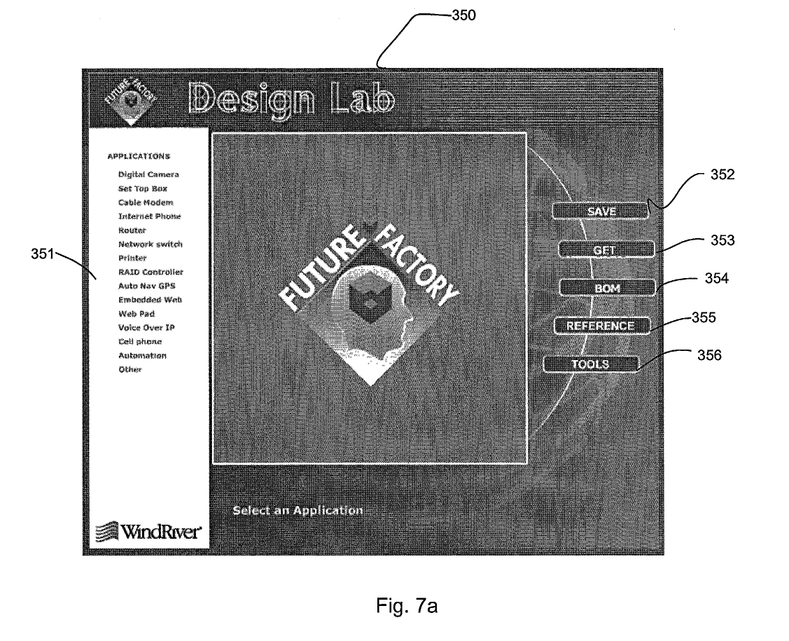

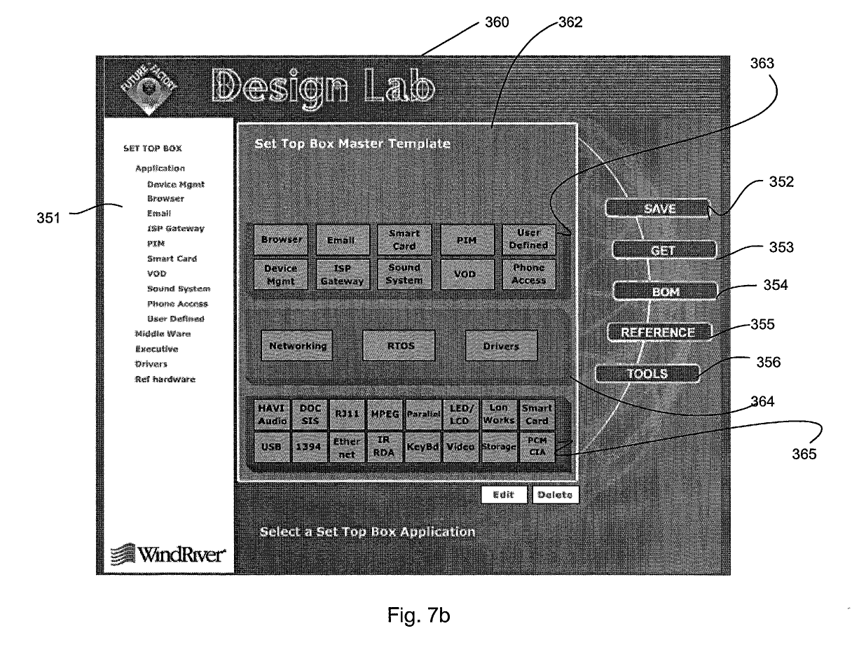

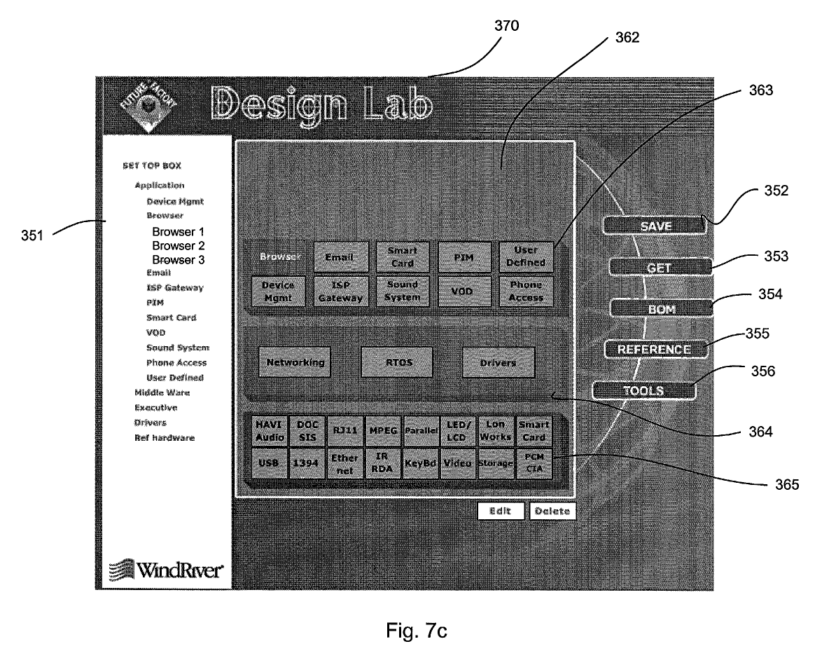

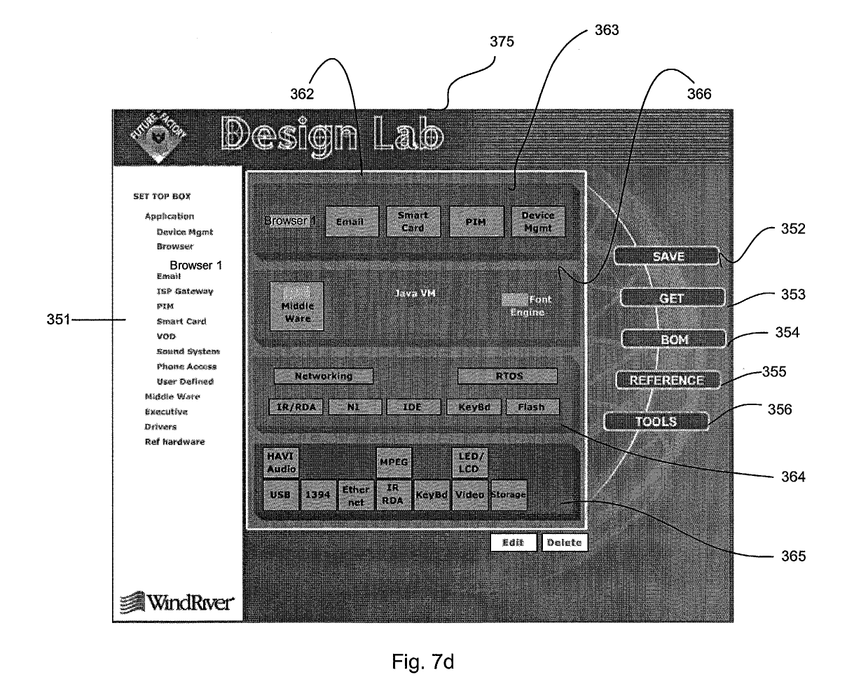

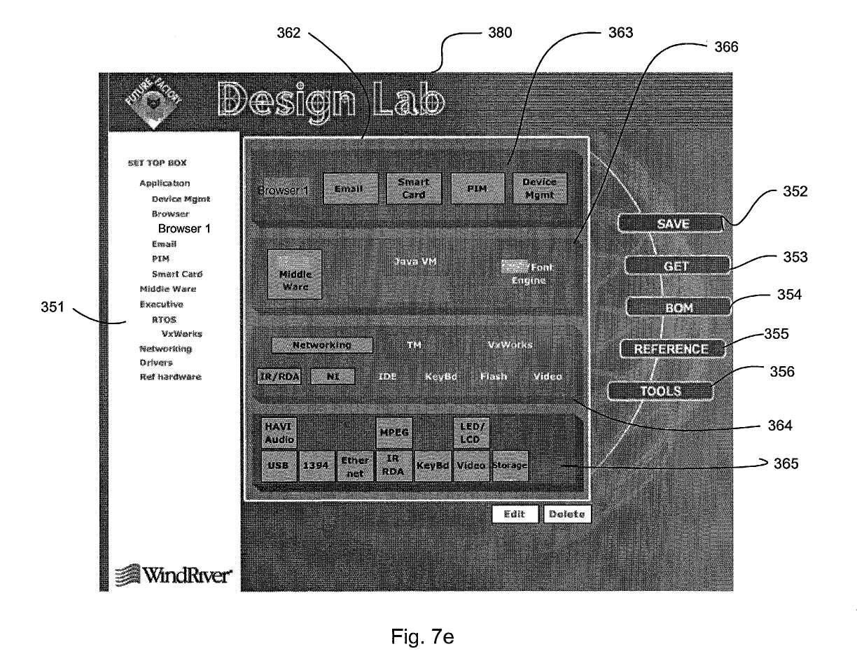

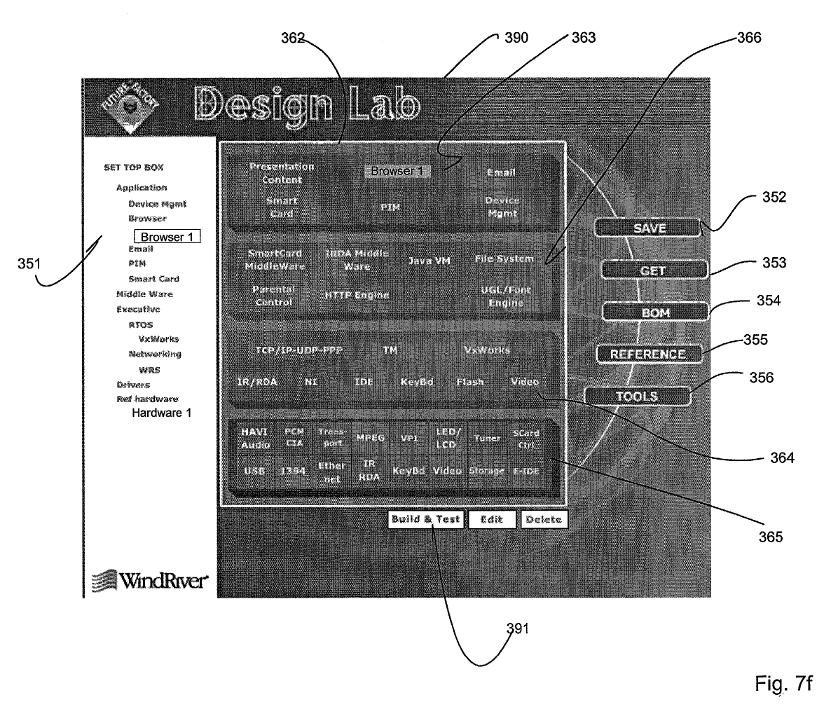

FIG. 6 shows an exemplary process flow for the use of solution module 200. In step 300, client 105 specifies the type of application to be designed. This selection is made by client 105 by interface with graphical user interface (“GUI”) 240 which may, for example, present a list of applications on the display monitor of user station 110. FIG. 7a shows exemplary GUI 350 which may be a feature of GUI 240. GUI 350 is an exemplary GUI from the Future Factory Design Lab application developed by Wind River Systems, Inc. of Alameda, Calif. GUI 350 may be used to present the list of applications to client 105. For example, GUI 350 has list 351 which contains a list of applications that client 105 may select, e.g., digital camera, set top box, cable modem, internet phone, etc. GUI 350 also contains buttons 352-356. Save button 352 allows the user to save the current design in a file. Get button 353 allows the user to retrieve a previously saved design. Tools Button 356 allows the user to access links to other tools that may be provided as part of software development tools 61-81 or any other tool that may be linked with software development tools 61-81. BOM button 354 and reference button 355 will be described in greater detail below. List 351 and buttons 352-356 are common to all the GUIs that will be discussed in reference to FIGS. 7a-f. However, the information contained in list 351 may change for different GUIs. Those skilled in the art will understand that the applications in list 351 is not exhaustive and any number of applications may be included in the list. Client 105 may select any of the applications listed in list 351 for the type of application to be designed. As described above, reference design library 210 contains the reference designs or templates for each of the applications in list 351. Reference design library 210 may contain numerous reference designs, therefore GUI 350 may provide client 105 with a feature to narrow down the choices of applications. For example, client 105 may enter a brief description of the application (e.g., cell phone) and solution module 200 may then provide only reference designs that are applicable to the description provided by client 105.

After client 105 selects the application in step 300, solution module 200 displays the reference design in step 305 for the application selected by client 105. FIG. 7b shows an exemplary GUI 360 displaying an exemplary reference design 362 for a set top box application, i.e., client 105 selected set top box from list 351 on GUI 350. In this exemplary embodiment, the reference design stored in reference design library 210 is in the form of a master template. As described above, GUI 360 contains the same buttons 352-356 and list 351 as GUI 350. However, the information contained in list 351 has changed based on the selections made by client 105. Reference design 362 initially has three layers in the template, software application layer 363, executive layer 364 and hardware layer 365. Each of layers 363-365 have blocks corresponding to hardware or software functions contained within these layers. For example, software application layer 363 has a browser block and an Email block and executive layer 364 has a Real Time Operating System (“RTOS”) block. In this exemplary embodiment, the blocks in each of layers 363-365 are generic blocks describing a function that may be included in the design of the set top box. The blocks included in reference design 362 may be those that vendor 55 has determined to be standard functions for a set top box. As will be described in greater detail below, client 105 may use reference design 362 as shown in FIG. 7b or modify reference design 362 to exclude those functions that are not needed or include additional functions. Client 105 may decide that reference design 362 is not the desired design and may want a different design for a set top box. In such a case, client 105 may press reference button 355 to determine if there are other reference designs for set top boxes contained in reference library 210. For example, reference library 210 may contain another reference design in the form of a template for a set top box or it may contain a more detailed reference design that already includes hardware or software from a specific vendor. Thus, reference library 210 is not limited in any manner to the number or type of reference designs that it may include.

If client 105 is going to continue using reference design 362, the process then continues to step 310 where client 105 may select a layer within reference design 362 to customize. Client 105 may select the layer to customize by, for example, using a mouse to click on the layer or by clicking on the layer name in list 351. Those skilled in the art will understand that reference design 362 may be shown on GUI 360 in manners other than the layering model shown in FIG. 7b. For example, reference design 362 may be shown as a block diagram in the form of FIG. 5. Where reference design 362 is shown in other manners, the area or region to be customized may be selected in an appropriate manner. Referring back to FIG. 7b, client 105 may have selected software application layer 363 to begin customizing. List 351 may display the application software that may be selected (e.g., device mgmt, browser, email, ISP gateway, etc.) by client 105.

In step 315, client 105 makes a component or block selection within the layer to customize. For example, client 105 may have selected the browser block of software application layer 363 to customize. FIG. 7c shows an exemplary GUI 370 displaying exemplary reference design 362 where list 351 has changed reflecting the selection of the browser box by client 105. List 351 changed to display the choices for the different types of browsers that may be selected by client 105 for the set top box application. In the exemplary GUI 370, the browsers are listed as Browser 1, Browser 2 and Browser 3. In an actual implementation, the commercial names of the browsers may be listed. Additionally, prior to displaying the browsers on list 351, client 105 may get additional prompts from solution module 200 in reference to browser selection. For example, solution module 200 may request whether client 105 desires to build or buy the browser. If client 105 is going to build a browser on its own, GUI 370 does not need to display browsers in list 351 because client 105 will be supplying the browser. In this case, the design may be saved with an indication that client 105 will be supplying the browser and client 105 may continue with the process for other components or blocks. If client 105 indicates the desire to buy a browser, solution module 200 may request the type of browser client 105 desires to include in the set top box application, e.g., Java browser, C++ browser, etc. After having received this information from client 105, solution module 200 may then display via list 351 on GUI 370, the appropriate browser choices. For example, client 105 may have selected Java type browsers and therefore, list 351 of GUI 370 displays Browser 1, Browser 2 and Browser 3 (Java type browsers). If client 105 had selected C++ type browsers, list 351 may have displayed Browser 4 and Browser 5 (C++ type browsers).

Those skilled in the art will understand that list 351 is not the only manner in which the selections of the components may be shown, other examples may include pull-down menus, nested menus, tree charts, spread sheet printouts, etc. GUI 240 may include any type of user interface to display selections to client 105. Additionally, client 105 may have the ability to highlight the choices (e.g., Browser 1-3) and GUI 240 may display information about the component. The GUI for this type of display is not shown in the Figures. In the case of a software component such as a browser, this information may include the developer, language compatibility, etc.

Continuing with the set top box example, client 105 may select Browser 1 from list 351 to include in the set top box. FIG. 7d shows an exemplary GUI 375 where reference design 362 has been changed based on the client's selection of Browser 1. As described above, analysis module 230 contains a knowledge base of the interactions between components in component library 220 and designs in reference design library 210. In this exemplary embodiment, the selection of Browser 1 by client 105 caused analysis module 230 to alter reference design 362. For example, analysis module 230 inserted a new layer 366 between software application layer 363 and executive layer 364. New layer 366 contains blocks for additional middleware, a Java Virtual Machine and a Font Engine. In other words, analysis module 230 determined that the selection of Browser 1, required the additional blocks in new layer 366 for the set top box to be functional. Additionally, there were changes in the blocks displayed in layers 363-365. These changes were also made by analysis module 230 based on the selection of Browser 1 by client 105. When client 105 is finished with the component selection for the browser, client 105 may save the design information by pressing save button 352 and the updated design information is saved by solution module 200. Client 105 may, at any time, go back and make another selection for the particular component and save this new selection as part of the current design or may save multiple designs to determine which best suits the design requirements.

The process then continues to step 320 to determine whether client 105 will make any additional component selections in the current layer. If additional components are to be selected, the process continues to step 325 for client 105 to make additional component selections. For example, to continue with the set top box example, client 105 may continue to select particular components for the email function in software application layer 363. List 351 may then display the choices of software components to provide the email function for the set top box. As described above, analysis module 230 contains information about the relationships between different components. Thus, when client 105 selected Browser 1, analysis module 230 may determine that certain email components in component library 220 are not compatible with Browser 1. Thus, analysis module 230 will select only the appropriate components to display on list 351 (i.e., the non-compatible email components will not be displayed). In this manner, client 105 does not need to review all the available components, only those indicated by analysis module 230 as compatible with the previously selected components. Client 105 will make the email selection, analysis module 230 will update the design in accordance with the selection and client 105 will save the updated design with the email selection.

Those of skill in the art will understand that it is also possible to maintain the information about the interrelationships of various components within the components themselves rather than in a separate analysis module 230. In such a case, the information described as contained in analysis module 230 would be contained in the component information in component library 220 meaning that analysis module 230 would be an integral part of component library 220. Using the browser and email example described above, the selected browser may contain information about email components with which it is compatible or email components with which it is not compatible. Similarly, the email components may contain compatibility information about browsers. A further example may be that when a particular component is selected, the component may contain information concerning other components that may be required based on the selection or that are suggested based on the selection. More specifically, client 105 may select a Java based browser component which has information that indicates that when this component is used, it requires a Java Virtual machine component. The Java based browser component may also include information that it is suggested that a particular RTOS be used in conjunction with the browser. Similarly, the information described as contained in analysis module 230 may also be maintained in reference library 210.

Steps 320 and 325 are repeated until all the components required for this design in the selected layer have been selected and saved. The process then continues to step 330 to determine whether there are any other layers to customize. If so, the process loops back to step 315 so that component selections for the next layer may be made. To continue with the example of the set top box, client 105 may desire to customize executive layer 364 by, for example, clicking on the middleware on list 351 or clicking on executive layer 364 in the design. FIG. 7e shows an exemplary GUI 380 where client 105 selected the RTOS block of executive layer 364 to customize. List 351 displayed the options for the RTOS block (i.e., VxWorks® RTOS distributed by Wind River Systems, Inc. of Alameda, Calif.). Client 105 selected VxWorks®, analysis module 230 updated the design in accordance with the selection of VxWorks®, and client 105 saved the updated design. Again, steps 320 and 325 are repeated until all the components required for this design in executive layer 364 have been selected and saved.

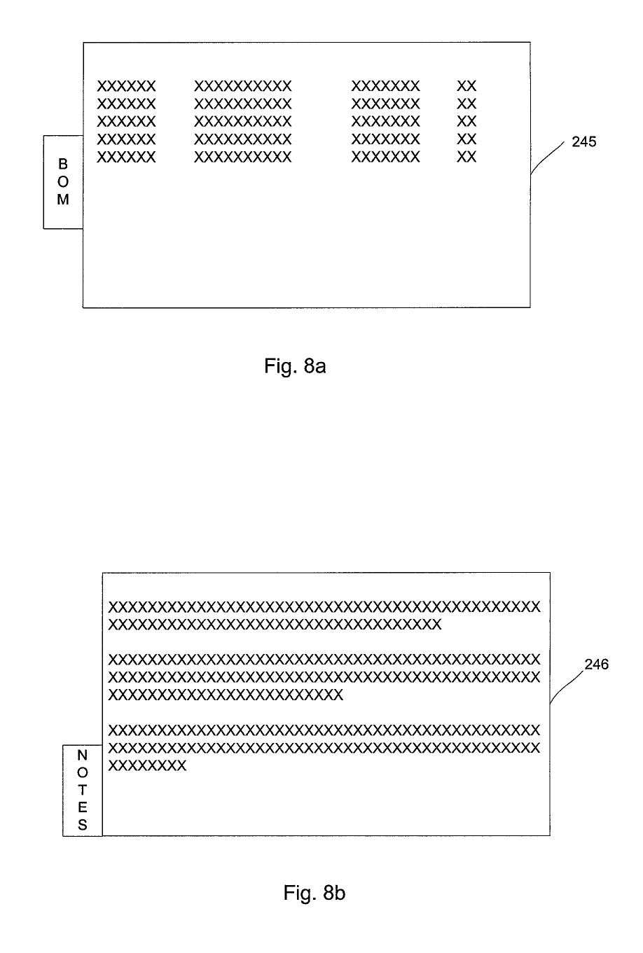

When the design for all the layers of the application have been completed, the process continues to step 335 where the design output is provided to client 105. FIG. 7f shows a completed design for a set top box. The components to provide the functions for each of layers 363-366 have been selected. The design output may be, for example, in the form of an updated design diagram (e.g., the design of FIG. 7f), a bill of materials (“BOM”), technical notes, etc. The design output may be displayed, printed, saved in a file etc., by pressing BOM button 354. As described above, each time client 105 makes a new component selection, the selection may be saved and the device design is updated to reflect the current information. Thus, the output is available to client 105 at any time during the design process by pressing BOM button 354. FIGS. 8a-b show exemplary views 245-246 of GUI 240 of solution module 200. Exemplary view 245 is a bill of materials which lists all the components that have been selected along with the attributes of these components. The bill of materials is also updated each time a component selection is made. Exemplary view 246 illustrates design notes made by client 105 that client 105 may refer to during the design process. Those skilled in the art will understand that the process described above with reference to FIGS. 7a-f is only exemplary and that it may be performed in other manners. For example, client 105 may select all the hardware components first and then the software components, or may select components on alternating layers until the design is complete. Solution module 200 may include user preference settings that are settable by client 105 in order to control the manner in which solution module 200 behaves during operation (e.g., selection of hardware components or software components first, etc.).

The output of solution module 200 preferably provides client 105 with a complete design including a block diagram, a bill of materials, estimated performance of the design and the cost of the design. Client 105 using solution module 200 remotely may access all this information in the absence of a face to face interaction with an application engineer. This also allows vendor 55 to market and sell complex products to remote settings. Solution module 200 may also have a facility which links client 105 to the vendors of the hardware and software components selected during the design process. For example, if client 105 selects a software component created by a particular company, solution module 200 may provide a link to that company so that client 105 may purchase the selected software component. Vendor 55 may receive a commission or other consideration for directing client 105 to the seller of the software component.

In an alternative embodiment, client 105 may have the option to select additional components that are not initially displayed by solution module 200 for any of a variety of reasons. In this alternative embodiment, the GUIs in FIGS. 7a-f may have an additional button or interface for client 105 to view additional components. Client 105 may then select these additional components for inclusion in the device design. One manner of including these additional components may be through highlighting, dragging and dropping the component in the desired location on the design. Using the set top box example started above, when client 105 desired to make the email selection, analysis module 230 may not have displayed a particular email component because it was not compatible with the browser selection. However, client 105 may have wanted to use the email component that was not displayed. In such a case, client 105 may press a button to display the email components not initially displayed. Client 105 may then select the desired email component and drag and drop it into the design. Analysis module 230 may then cause GUI 240 to indicate there is an incompatibility in the design and display the incompatibility (e.g., browser and email are not compatible). Client 105 may then amend the design to deal with the incompatibilities.

Another example of the alternative embodiment is where a reference design does not include a certain feature that client 105 wishes to include in the design. For example, referring to FIG. 7b, reference design 362 for the set top box does not include a serial port. Client 105 may want to include a serial port in their set top box. GUI 360 may provide client 105 with an option to select other components from component library 220 where the function of that component was not included in the reference design. A final example of the alternative embodiment may be that client 105 desires to build the device from the ground up selecting each of the components from a component list without the aid of a reference design. In such a case, GUI 240 may display the components from component library 220 and client 105 may drag and drop the components to make a new design. Analysis module 230 may will still be used because, as client 105 selects components, analysis module 230 may indicate other desirable components or incompatible components. Additionally, when building from the ground up, client 105 may input the desired features or functions that the component should contain or perform. Analysis module 230 may then take these desired features and functions input by client 105, compare these to the features and functions of the components contained in component library 220 and suggest components to client 105. For example, when selecting hardware components, client 105 may desire only those boards or chips with 128 Mbyte of Random Access Memory (“RAM”). Thus analysis module 230 will eliminate those hardware components that do not meet this criteria.

In another alternative embodiment, client 105 may allow analysis module 230 to populate the reference design with specific components from component library 220. For example, referring to FIG. 7b, client 105 may determine that reference design 362 has all the functions that client 105 desires for the selected application. However, client 105 may not want to select individual components from different vendors to satisfy all these functions. In this case, there may be an interface on GUI 260 that allows client 105 to indicate that analysis module 230 select the individual components to satisfy the functions desired in the device by client 105. Analysis module 230 may make these decisions based on the relationship information it contains about the individual components. Similarly, client 105 may not desire a particular function and/or may desire additional functions. In such a case, client 105 may be able to drag and drop functions in and out of the reference design in much the same manner as individual components may be moved in and out of a design. When the design contains only the functions desired by client 105, analysis module 230 may then select the individual components to satisfy these functions.

The output of solution module 200 may also include a measure of the risk that a particular design may not operate as desired. For example, the output may indicate a degree of confidence that the various components will work together in the selected design as intended as, for example, a percentage. Thus, if client 105 uses a reference design and selects only those components which are displayed based on the recommendation of analysis module 230, the output from solution module 200 may include an indication of 100% confidence that the design will work, i.e., this design is certified by vendor 55. However, if client 105 modifies the reference design by, for example, dragging and dropping a component that was not included in the reference design, a lower degree of confidence may be warranted. The level of this lower degree of confidence may be determined by analysis module 230 based on a variety of factors including, whether the component is a standard component, the interrelationship of the component with other components in other designs, the general degree of compatibility of the component, etc. For example, a standard design may specify the use of a USB port for a particular device, but client 105 may desire to use an IEEE 1394 connection. The modified design may have a confidence level of, for example, 90% based on the fact that IEEE 1394 connection is a standard component that has some history of use in other reference designs with components that are similar to the current design. If client 105 builds the device from the ground up, it is likely that the degree of confidence will be low, because vendor 55 will not have experience with the combination of components that client 105 assembles. Additionally, if client 105 provides components that solution module 200 is not familiar with (e.g., client 105 builds a stand alone browser), the degree of confidence may be low.

Another application that may be included in software development tools 61-81 is a target testing module which assists clients 105 in testing the designed devices. Referring to FIG. 7f, GUI 390 contains a build and test button 391 which may be used by client 105 to test the device which has been assembled using solution module 200. As will be described in greater detail below, vendor 55 (or other partner of vendor 55) may maintain a number of boards or target devices that may be accessed by client 105 to test the design. The most likely target devices maintained will be those resembling the reference designs. However, vendor 55 may maintain any number of target devices comprising any combination of hardware onto which software components may be loaded or unloaded based on the testing needs of individual clients 105. Those skilled in the art will understand that the target testing module that will be described may be a stand-alone item which may be used in conjunction with the solution module.

Referring back to FIG. 1, cross-development software suite 10 includes tools that interact with a target computing environment: logic analyzer 18, target browser 19 and target server 17 facilitate communication between the tools of cross-development software suite 10 and a target computing environment. These tools will be described in greater detail below. To implement the target testing module, vendor 55 provides a collection of remotely accessible target systems. Each of the remote target systems is accessible via a network connection. The collection of target systems may be physically isolated to prevent unauthorized access and provide physical safety, and may consist of a number of different types of target computing environments distributed over a number of physical sites. Cross-development environments may be deployed in host systems remote from the collection of target systems, and access may be provided to the target systems via the network. As a result, target systems do not need to be located near the cross-development environments, and quick access may be had to different types of target systems without the need for local installations.

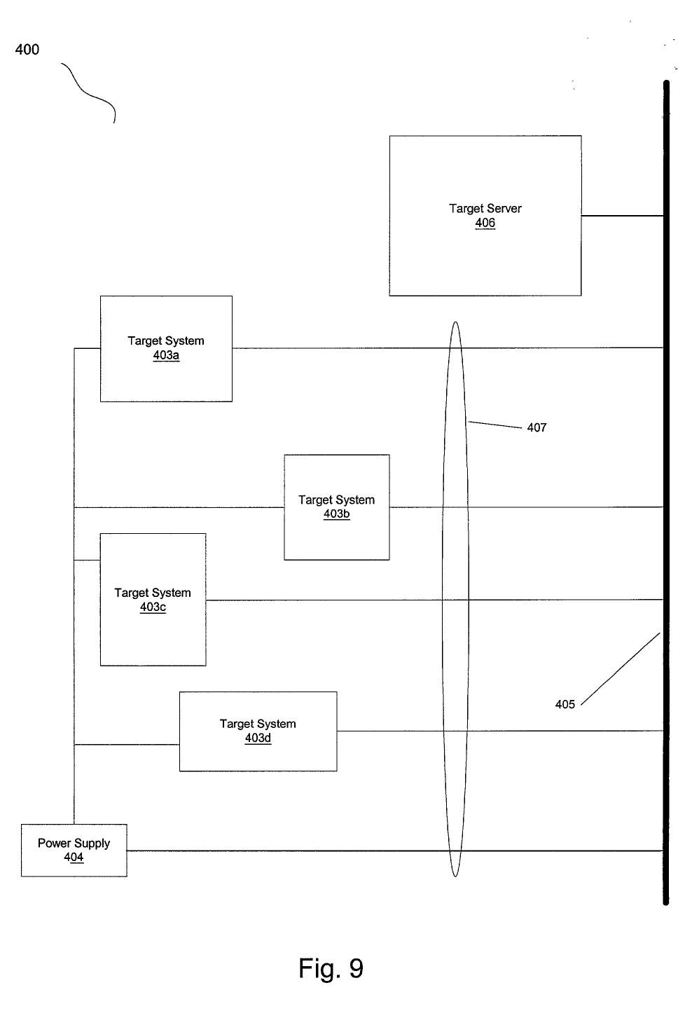

FIG. 9 illustrates an example of an implementation and use of remote target collection 400 which includes a number of target systems 403, target server 406 and power supply 404. Each of target systems 403 may comprise a different computing environment and may include “evaluation,” “development” or “reference” systems (also referred to as “evaluation boards” or simply “boards”) that provide a computing environment similar to the ultimate computing environment for the application under development. Target systems 403 may, of course, also include actual devices comprising the ultimate computing environment for the application. The collection of target systems 403 may be physically mounted in a single backplane and located in an isolated area (e.g., a restricted access lab) which allows for climate control and security. Alternatively, target systems 403 may be physically located in multiple separated locations (e.g., different facilities within a single company). Power supply 404 may be an uninterruptable power supply, and the various target systems 403 may be powered via a single or multiple power supplies 404. Each target system 403 is connected to a network 405 via connections 407. These connections 407 may be Ethernet connections to an Ethernet network, or other well known networking transmission format.

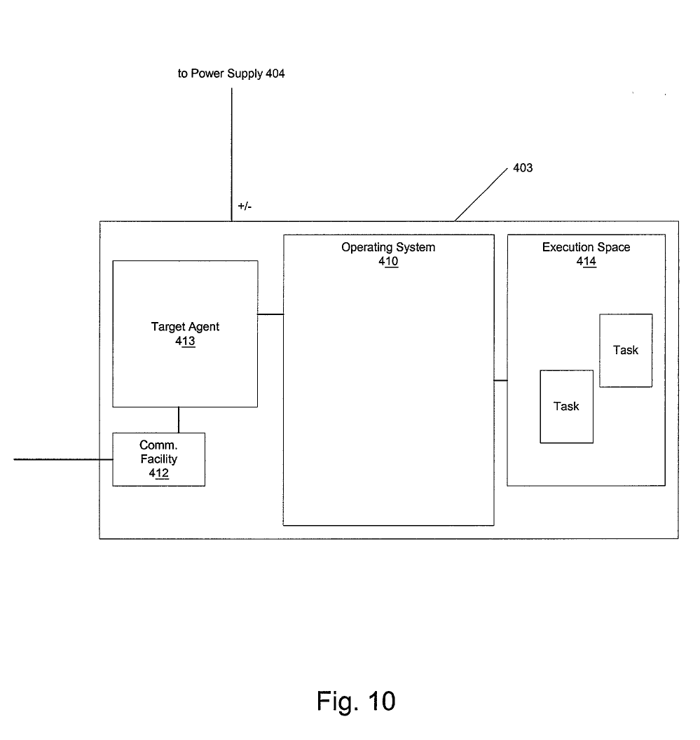

FIG. 10 illustrates an example of target system 403 which may include a variety of computing resources—flash memory, display, keypad, disk system, are common examples—and includes at least one processor (such as those provided by Intel®, Motorola®, ARM®, and Texas Instruments®). Target system 403 also includes operating system 410—for example, the VxWorks® real-time operating system provided by Wind River Systems, Alameda, Calif. Operating system 410 is loaded and executed in target system 403, for example, through the use of a bootstrap loading procedure executed upon the powering of target system 403, as is generally known. Target system 403 further includes communication facility 412 (which may be provided as part of operating system 410), which allows for communication between target system 403 and the outside world. In the specific example shown in FIG. 10, communication facility 412 is an Ethernet connection, although as would be understood by those skilled in the art, additional connection protocols may be used. Target system 403 also includes an execution space 414 (e.g., a memory space of addressable memory, such as RAM), which may be loaded with software that may be executed as part of one or more tasks.

Also included in target system 403 is target agent 413 which may provide facilities to respond to “requests” from host tools (further described below) that may attempt to communicate with target system 403 via communication facility 412—for example, for memory transactions, breakpoint services, event services. Target agent 413 may also provide facilities to interface with operating system 410, the computing resources that are part of target system 403, and any tasks that may be executing in target system 403. Target agent 413 itself may be executed as a task within operating system 410, or as an independent run-time entity.

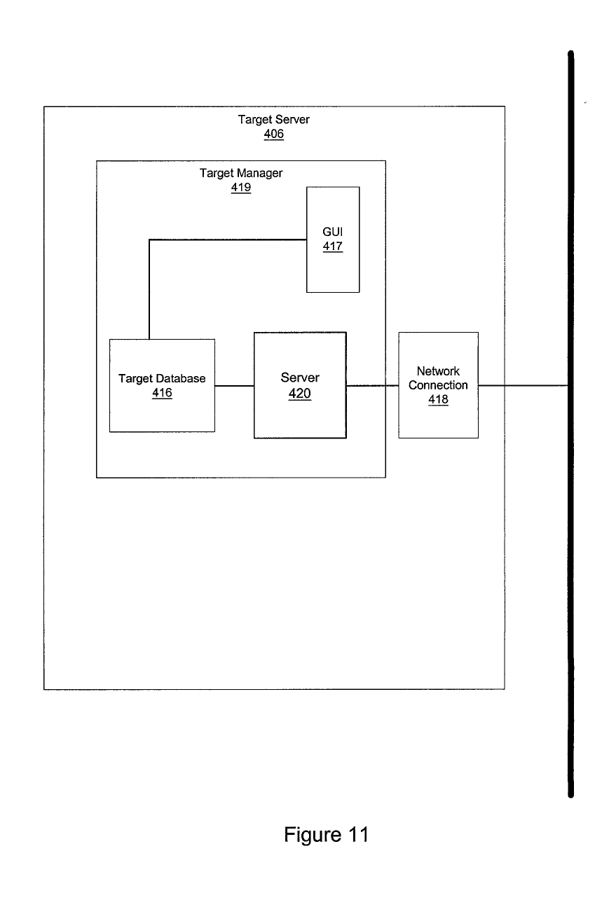

Also connected to network 405 is target server 406 of which an example is illustrated in FIG. 11. Target manager 419 is running on server 406, which controls access to target systems 403. Target manager 419 includes GUI 417 to allow an administrator to configure connection parameters for target systems 403 and perform various setup and maintenance activities (as will be described further below). Target manager 419 further includes target database 416 which includes information concerning each target system 403 available via network 405, and target manager server 420, which responds to requests from individual clients 105 for information about specific target systems 403 (which will be further explained below). Target server 406 also includes network connection facility 418 that allows for communication between the server 406 and network 405. Network connection facility 418 may comprise typical networking services used to allow networking transmissions, and in the present example comprises Ethernet networking facilities. Those skilled in the art will understand that target server 406 may be the same server as application server 90 or it may be a separate server.

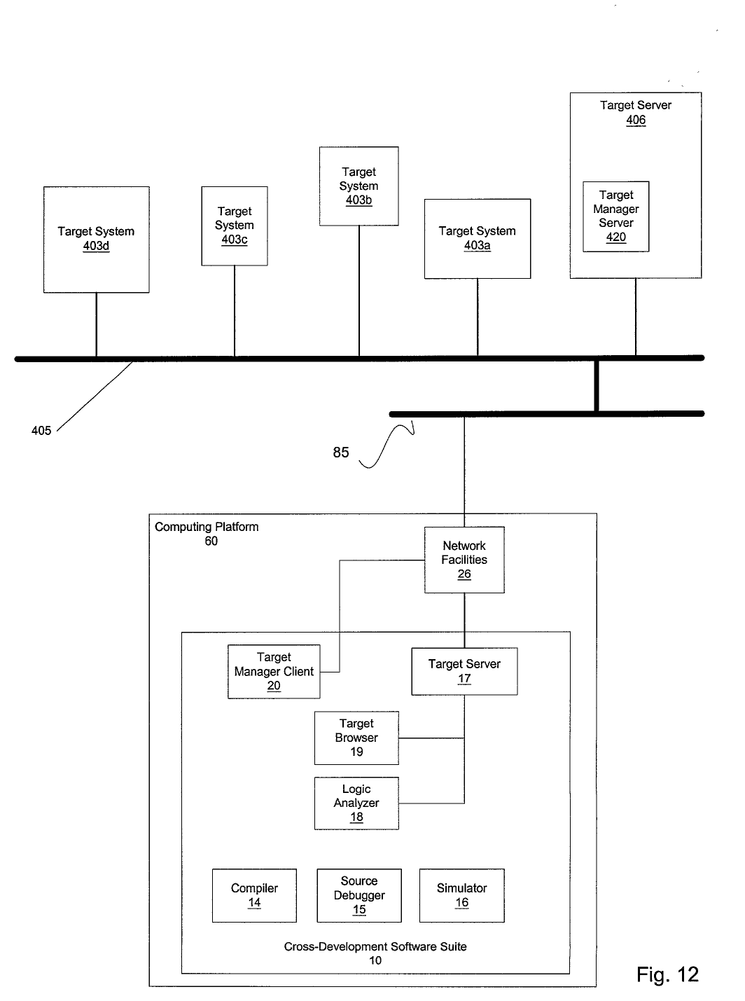

Network 405 may be considered an extension of network 85 illustrated in FIG. 2. FIG. 12 illustrates a connection between cross-development software suite 10 running on computing platform 60 and target collection 403. Cross-development software suite 10 includes a number of tools for use in software development: compiler 14, source debugger 15, simulator 16, target browser 19 and logic analyzer 18. Other tools may also be included. The tools are coupled to target server 17, which provides a facility for communicating with target systems 403 via networks 85 and 405. Cross-development software suite 10 further includes target manager client 20 which allows the user of cross-development software suite 10 to access target manager 419 running on target server 406 to obtain information concerning the status of target systems 403, and to obtain access to target systems 403 for use in performing application testing. Target manager client 20 uses network facilities 26 to pass messages to target manager server 420 provided as part of target manager 419.

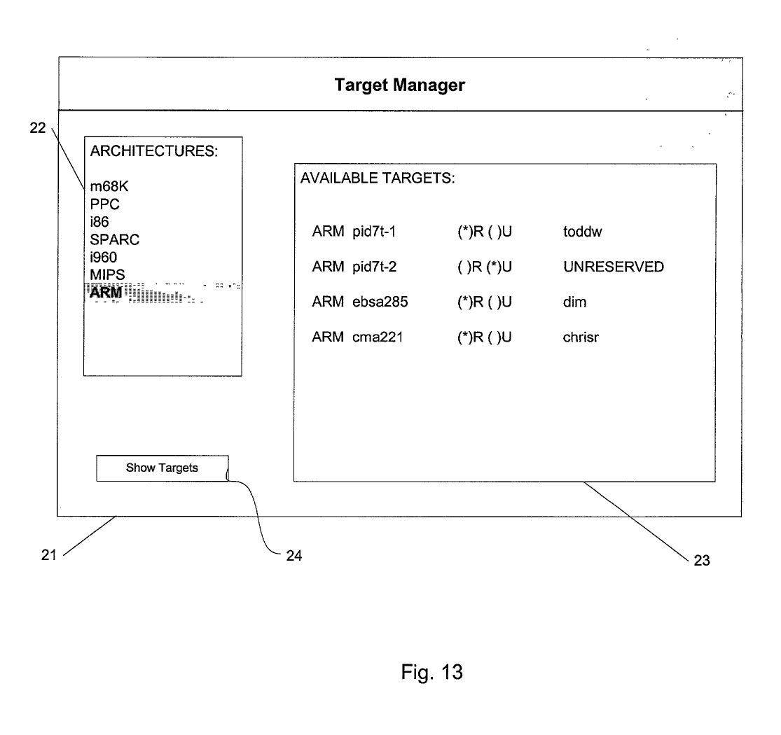

Target manager client 20 also provides a GUI 21 to allow client 105 to view target system 403 information. An exemplary GUI 21 is illustrated in FIG. 13. Target systems 403 may be sorted in GUI 21 based on the type of processor used by the target: as shown in FIG. 13, seven supported processor types are listed in architecture window 22 (“m68K,” “PPC,” “i86,” “SPARC,” “i960,” “MIPS,” “ARM”). Client 105 may select a desired processor architecture (for example, using an input device such as a mouse), causing target systems 403 available to client 105 over the network 405 to be displayed in target window 23. As shown in FIG. 13, client 105 has selected the “ARM” processor family in architecture window 22, causing four target systems 403 to be displayed in target window 23 which use ARM processors. GUI 21 shows client 105 which targets are available for use. For example, as shown in FIG. 13, for each target system displayed in target window 23, an indicator of whether the target system 403 has been reserved or unreserved, and the user name of the client that has reserved the target system 403 is displayed. As shown in FIG. 13, three of the four target systems 403 are presently reserved by other clients (user names “toddw,” “chrisr,” “dim”) and are thus temporarily unavailable to client 105. There may also be other GUIs available to client 105 to show different features of the target systems. For example, client 105 may be able to view a block diagram, wiring diagram, board schematic, bill of materials, etc. for the target systems.

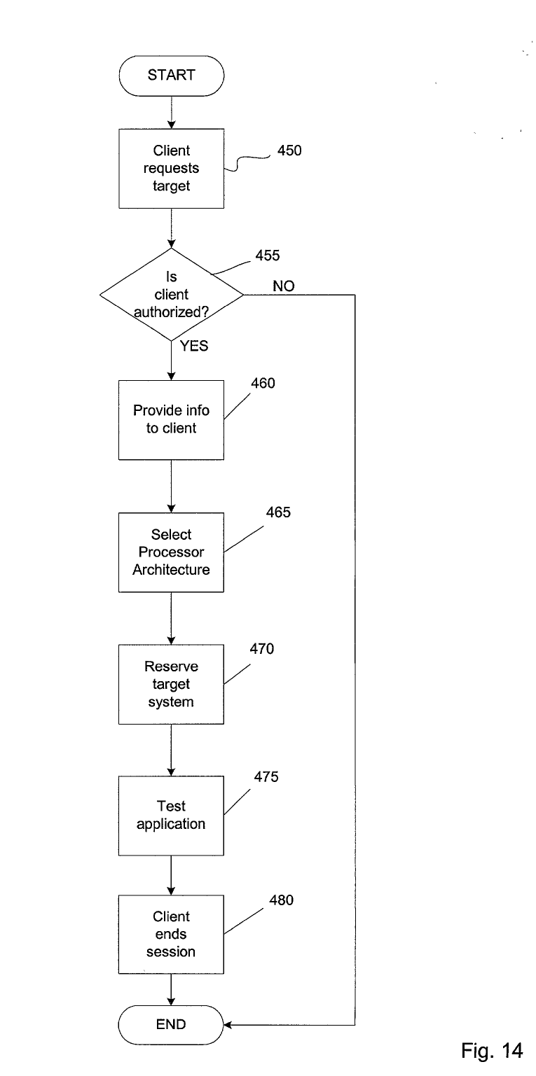

FIG. 14 shows an exemplary process flow for operation of target systems 403. In step 450, client 105 executes target manager client 20 on computing platform 60. It should be noted that client 105 may access computing platform 60 directly or indirectly via remote system 50 described with reference to FIG. 2. The operation of remote system 50 has been previously described above and will not be repeated here except to note that the steps and procedures to remotely access to any of the tools offered in cross-development software suite 10 is generally the same. Target manager client 20 communicates over networks 85 and 105 with the target manager server 420 running on server 406 using network facilities 26. Specifically, target manager client 20 provides the user name of client 105. In step 455, target manager 419 verifies that client 105 has access privileges to the target information. If client 105 does not have access privileges, the process ends. If client 105 is authorized, the process continues to step 460 where target manager 419 provides to target manager client 20 information concerning target systems 403—target system names, processor family types, and reservation status. Target manager client 20 displays this information to client 105 via GUI 21. In this example, only the supported processor types are displayed in architecture window 22. Client 105 then selects the processor architecture that is desired for the target system in step 465. For example, client 105 highlights the desired architecture and selects the “Show Targets” button 24, causing the available target systems matching the selected processor architecture to be displayed in target window 23.

In step 470, client 105 may then reserve an unreserved target system by selecting a reservation button corresponding to the desired target. Upon selecting the reservation button, target manager client 20 communicates with target manager 419 indicating that client 105 has requested a reservation of the selected target system. Target manager 419 updates target database 416 with the user name, and communicates with target manager client 20 to update target window 23 with the reservation for client 105. Once the reservation has been made, client 105 may then use the cross-development environment to perform application debugging using target system 403 in step 475. Client 105 configures target server 17 to connect with the target system 403, for example, by using the target name associated with the reserved target system 403. When client 105 has completed use of target system 403, the process continues to step 480 where client 105 again executes target manager client 20 in order to unreserve the target system 403. According to this exemplary embodiment of the present invention, access to multiple remote targets connected over a network may be managed, allowing sharing of multiple targets among multiple users.

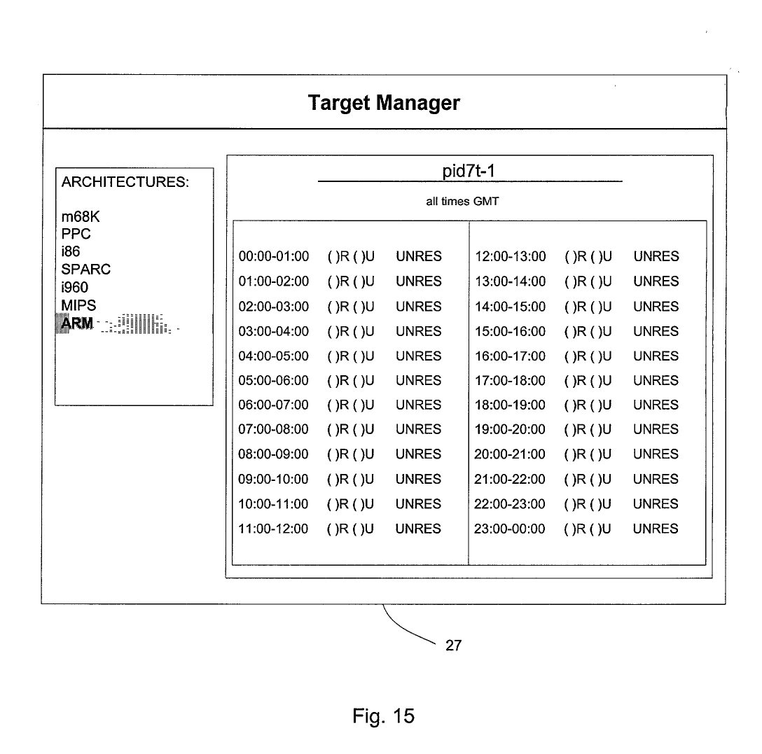

Another exemplary process that may be used to access remote target collection 403 is the addition of a time scheduler in the reservation process. In this case, in step 460 when target manager 419 provides information concerning target systems 403 to target manager client 20, it also provides a schedule of when target systems 403 are available for use. FIG. 15 shows exemplary GUI 27 which shows the status of a particular target system over a 24 hour period. Client 105 may then make a reservation for the particular target system for any time during that 24 hour period or any period that is displayed by GUI 27. It may also be possible for a GUI to display pricing information for the renting or leasing of a target system 403 so client 105 is aware of how much the scheduled time on the target system will cost.

In the preceding specification, the present invention has been described with reference to specific exemplary embodiments thereof. It will, however, be evident that various modifications and changes may be made thereunto without departing from the broadest spirit and scope of the present invention as set forth in the claims that follow. The specification and drawings are accordingly to be regarded in an illustrative rather than restrictive sense.

What is claimed is:

1. A software package for application development comprising:
an input module for receiving from a user information corresponding to a desired application to be developed;
a reference database including data on each of plurality of categories for which the application may be developed;
a component database storing a plurality of design components therein; and
an analysis module which selects from the component database design components suitable for the desired application based on the user information and the data in the reference database.

2. The software package according to claim 1, wherein, before indicating to a user that a present design component is suitable, the analysis module determines whether the present design component is compatible with previous design components already indicated as suitable for the present desired application.

3. The software package according to claim 2, wherein, if a present design component is indicated as incompatible with any previous design component, the analysis module provides this data to the user.

4. The software package according to claim 3, further comprising:
a revision module allowing a user to alter a previous design component based on an indication that a present design component is incompatible therewith.

5. The software package according to claim 4, wherein the revision module allows a user to alter all previous design components.

6. The software package according to claim 1, wherein each of the plurality of categories relates to a corresponding one of a plurality of devices and wherein the design components are one of hardware components and software components to be included in the at least one of the plurality of devices.

7. The software package according to claim 1, further comprising:
a first interface module interfacing with a user computer running on a computer separate from a computer on which the software package is running, the first interface module allowing a user of the user computer to run the software package.

8. The software package according to claim 7, wherein each of the plurality of categories relates to a corresponding one of a plurality of devices, the software package further comprising:
a second interface module interfacing with a device forum including a plurality of device environments, the second interface allowing a user to test an application developed using the software package in a selected one of the device environments corresponding to a target device in which the developed application is to be run.

9. The software package according to claim 8, wherein each of the device environments includes hardware corresponding to the hardware on which the developed application would be run in the target device.

10. The software package according to claim 7, wherein the first interface module provides a graphical user interface on a user computer separate from a computer on which the software package is running.

11. The software package according to claim 1, wherein the input module includes a graphic user interface module for receiving information from the user.

12. A system, comprising:
a plurality of device emulation environments, each of the device emulation environments emulating the operation of a corresponding target device;
a server coupled to the plurality of device emulation environments and accessible to a user computer via a communications network, wherein the server runs a software package including a first interface module receiving from the user data corresponding to a software application to be run on a first one of the target devices, a second interface module selecting a first one of the device emulation environments corresponding to the target device and installing the software application in the first device emulation environment and a testing module testing the performance of the software application in the first device emulation environment.

13. The system according to claim 12, wherein the first interface outputs the results of the test to the user computer via the communications network.

14. The system according to claim 13, wherein the software package running on the server further comprises an operating system building module receiving data from a user regarding the target device and desired functionality of the operating system and assembling the software application from stored components based on the target device and desired functionality.

15. The system according to claim 13, wherein the software package running on the server further comprises a scheduler module monitoring usage of each of the plurality of device emulation environments and indicating to the user times at which the first device emulation environment is available.

16. A method, comprising the steps of:
displaying a plurality of categories for which an application may be developed;
receiving information from a user corresponding to the application desired to be developed;
displaying a plurality of design components which may be included in the application; and
receiving information from the user corresponding to the ones of the plurality of design components to include in the application.

17. The method according to claim 16, further comprising the step of:
displaying a reference design for the application to be developed.

18. The method according to claim 16, further comprising the step of:
excluding an incompatible design component from the plurality of design components, wherein the incompatible design component is determined based on previous design components included in the application.

19. The method according to claim 16, further comprising the step of:
testing the application on an emulation environment.
